(19) United States
(12) Patent Application Publication
(10) Pub. No.: US 2008/0303962 A1
(43) Pub. Date: Dec. 11, 2008

(54) LIQUID CRYSTAL PROJECTOR AND A METHOD OF CONTROLLING THE SAME

(75) Inventors: Hideo TOMITA, Kanagawa (JP); Michihiro Tobita, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/111,432

(22) Filed: Apr. 29, 2008

(30) Foreign Application Priority Data
Jun. 6, 2007 (JP) 2007-150074

(51) Int. Cl. G02F 1/13; G02F 1/1333

(52) U.S. Cl. 349/8; 349/15

(57) ABSTRACT

A liquid crystal projector for projecting a three-dimensional image includes: a liquid crystal panel to which a normal voltage and an inversion voltage are alternately applied; and a drive circuit for driving the liquid crystal panel in order of a first state corresponding to a first image signal, the first state corresponding to a second image signal, a second state corresponding to the first image signal, and the second state corresponding to the second image signal, one of the image signals for the left-hand and the right-hand eyes being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

### CROSS REFERENCES TO RELATED APPLICATIONS

The present invention contains subject matter related to Japanese Patent Application JP 2007-150074 filed with the Japan Patent Office on Jun. 6, 2007, the entire contents of which being incorporated herein by reference.

### BACKGROUND OF THE INVENTION

1. Field of the Invention

The present invention relates to a liquid crystal projector and a method of controlling the same, and more particularly to a liquid crystal projector which is suitable for being used when a three-dimensional image is displayed by using one liquid crystal projector, and a method of controlling the same.

2. Description of the Related Art

In former years, a screen image which was photographed in a film was screened on a screen in a theater. In recent years, however, as called a so-called digital cinema, such an image is recorded in the form of a digital image signal, and thus an image is screened which corresponds to the digital image signal transmitted to corresponding one(s) of theaters.

In the theater, the digital image signal transmitted thereto, for example, is reproduced by using a liquid crystal projector for projecting an image by using a liquid crystal device, and is displayed in the form of an image corresponding thereto on a screen.

In recent years, with regard to the image screened in the theater, there are also three-dimensional (3D) contents. In this case, the 3D contents are obtained by photographing a subject in such a way that a 3D stereoscopical image (hereinafter referred as “a 3D image”) is adapted to be displayed on a screen of the theater.

Heretofore, when the 3D image is projected by using a liquid crystal projector, the technique which uses two liquid crystal projectors is generally adopted. This technique, for example, is described in Japanese Patent Laid-Open No. Hei 8-331602. In this case, one liquid crystal projector projects an image for a right-hand eye of a user, and the other projects an image for a left-hand eye of the user.

In addition, recently, it is also attempted to project a 3D image by using one liquid crystal projector.

A description will now be given with respect to a method in the related art in the case where the 3D image is projected by using one liquid crystal projector with reference to FIGS. 1 to 3. In other words, the method which will now be described with reference to FIGS. 1 to 3 is an example in the case where the 3D image is projected in accordance with the same system as that when a normal two-dimensional image (2D image) is projected.

FIG. 1 shows an example of a construction of a 3D image projecting system for projecting a 3D image.

With the 3D image projecting system, an image signal for a left-hand (L-side) eye of a user and an image signal for a right-hand (R-side) eye of the user each of which is an image signal about a 3D image for a digital cinema are supplied in a cycle of 24 Hz to a liquid crystal projector 1.

An optical shutter 2 and a polarizing element 3 are disposed in front of the liquid crystal projector 1 in a direction of projecting an image by the liquid crystal projector 1. In this case, the optical shutter 2 blocks or transmits a light (image light) emitted from the liquid crystal projector 1. Also, the polarizing element 3 polarizes an incident light in a polarization direction corresponding either to the L-side or to the R-side. Liquid crystal elements are generally used as the optical shutter 2 and the polarizing element 3, respectively.

With the liquid crystal projector 1, the images corresponding to the image signal on the R-side or the L-side are successively written to a liquid crystal panel 1A, and the images thus written to the liquid crystal panel 1A are projected in order on a screen 4 by using a light source (not shown). That is to say, the image light emitted from the liquid crystal projector 1 passes through the optical shutter 2, and is then polarized in a predetermined polarization direction by the polarizing element 3 to be displayed on the screen 4.

The user wears polarizing glasses 5, and thus can see a 3D image because an image light for his/her left-hand eye and an image light for his/her right-hand eye are made incident to his/her left-hand eye and right-hand eye, respectively.

Now, for the liquid crystal device, for the purpose of preventing the deterioration or the like of the liquid crystal material thereof, it is necessary to perform the so-called A.C. drive for driving the liquid crystal material of the liquid crystal device so that the polarity of a voltage applied to the liquid crystal material is inverted at a predetermined timing, for example, in units of one picture, thereby making an integration value of a D.C. component zero. Here, one of the polarities of the applied voltage is called normal, and the other thereof is called inversion.

Hereinafter, the voltage applied to the liquid crystal material in a state of having the normal as its polarity is referred to as the normal voltage, and the voltage applied to the liquid crystal material in a state of having the inversion as its polarity is referred to as the inversion voltage.

For example, when the liquid crystal projector 1 successively displays time-series 2D images A, B and C, firstly, as shown in FIG. 2A, a normal voltage obtained by inverting the inversion voltage is applied to the liquid crystal of the liquid crystal panel 1A to display the image A on the screen 4. Next, the inversion voltage obtained by inverting the normal voltage is applied to the liquid crystal of the liquid crystal panel 1A to display the image A on the screen 4. Also, in the case as well where the next image B is intended to be displayed, after a normal voltage is firstly applied to the liquid crystal of the liquid crystal panel 1A in the liquid crystal projector 1 to display the image B on the screen 4, the inversion voltage is applied to the liquid crystal of the liquid crystal panel 1A to display the image B on the screen 4. This operation also applies to the image C.

Therefore, when the 3D image is intended to be displayed in accordance with the same system as that in the case of displaying the 2D image, as shown in FIG. 2B, the liquid crystal projector 1 displays a first L-side image L₁ at a certain timing by applying the normal voltage to the liquid crystal of the liquid crystal panel 1A, and next displays the image L₁ by applying the inversion voltage to the liquid crystal of the liquid crystal panel 1A. Moreover, for a next time period, the liquid crystal projector 1 displays a first R-side image R₁ by application of the normal voltage, and next displays the R-side image R₁ by application of the inversion voltage.

The image (panel image) written to the liquid crystal of the liquid crystal panel 1A, a drive polarity representing whether the driving operation for the liquid crystal projector 1 is performed by application of the normal voltage or the inversion voltage at that time, and a timing at which the optical shutter 2 is opened or closed are summarized as shown in FIG. 3.

After the image L₁ is written to the liquid crystal of the liquid crystal panel 1A for a time period T₁ by application of the normal voltage, the image L₁ is written to the liquid crystal of the liquid crystal panel 1A for a time period T₂ by application of the inversion voltage. In addition, for the time period T₂, the optical shutter 2 continues to be opened. The reason for this is that even when the optical shutter 2 continues to be opened at all times while the image L₁ is written to the liquid crystal of the liquid crystal panel 1A for the time period T₂, there is no problem because the image which is written to the liquid crystal of the liquid crystal panel 1A for the time period T₂ is same to that which was written for the time period T₁.

Likewise, after the image R₁ is written to the liquid crystal of the liquid crystal panel 1A for a time period T₃ by application of the normal voltage, the image R₁ is written to the liquid crystal of the liquid crystal panel 1A by application of the inversion voltage and also the optical shutter 2 continues to be opened for a time period T₄.

As described above, the liquid crystal projector 1 in the related art projects the images in order of the image L (corresponding to the normal), the image L (corresponding to the inversion), the image R (corresponding to the normal), and the image R (corresponding to the inversion) on the screen 4 by using the L-side and R-side image signals which are successively supplied thereto in the cycle of 24 Hz, thereby displaying the 3D image on the screen 4.

### SUMMARY OF THE INVENTION

However, with the system in the related art described above, one image having the paired L-side and R-side ones can be displayed only in the cycle of 24 Hz. Thus, the flicker heavily occurs, which results in that the satisfactory visibility can not be offered for the user.

The present invention has been made in the light of such circumstances, and it is therefore desire to provide a liquid crystal projector and a method of controlling the same each of which is capable of reducing flicker when a 3D image is displayed by using one liquid crystal projector.

In order to attain the desire described above, according to an embodiment of the present invention, there is provided a liquid crystal projector for projecting a three-dimensional image based on an image signal for a left-hand eye and an image signal for a right-hand eye, the liquid crystal projector including: a liquid crystal panel to which a normal voltage and an inversion voltage are alternately applied; and a drive circuit for driving the liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

According to another embodiment of the present invention, there is provided a method of controlling a liquid crystal projector including a liquid crystal panel to which a normal voltage and an inversion voltage are alternately applied, the liquid crystal projector serving to project a three-dimensional image based on an image signal for a left-hand eye and an image signal for a right-hand eye, the method of controlling a liquid crystal projector including the step of: driving the liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

According to the embodiment of the present invention, one of the image signal for the left-hand eye and the image signal for the right-hand eye is set as the first image signal, and the other thereof is set as the second image signal. Also, one of the normal state of the voltage applied to the liquid crystal panel, and an inversion state of the voltage applied to the liquid crystal panel is set as the first state, and the other thereof is set as the second state. Under this condition, the liquid crystal panel is driven in order of the first state corresponding to the first image signal, the first state corresponding to the second image signal, the second state corresponding to the first image signal, and the second state corresponding to the second image signal.

According to the embodiment of the present invention, it is possible to reduce the flicker when the 3D image is displayed by using one liquid crystal projector.

### BRIEF DESCRIPTION OF THE DRAWINGS

FIG. 1 is a view showing an example of a 3D image projecting system in the related art;

FIGS. 2A and 2B are respectively diagrams explaining operations for driving a liquid crystal panel in the related art;

FIG. 3 is a diagram explaining a concrete operation for driving the liquid crystal panel in the related art;

FIG. 4 is a block diagram showing a configuration of a 3D image projecting system according to an embodiment of the present invention;

FIGS. 5A and 5B are respectively diagrams explaining operations for driving a liquid crystal panel shown in FIG. 4 by using a liquid crystal projector shown in FIG. 4;

FIG. 6 is a diagram explaining a concrete operation for driving the liquid crystal panel shown in FIG. 4 by using the liquid crystal projector shown in FIG. 4;

FIG. 7 is a block diagram showing an example of a detailed configuration of a frame memory shown in FIG. 4; and

FIG. 8 is a flow chart explaining projection processing executed by the liquid crystal projector shown in FIG. 4.

### DETAILED DESCRIPTION OF THE PREFERRED EMBODIMENT

Although embodiment of the present invention will be described hereinafter, a correspondence relationship between the constituent requirements of the present invention, and the embodiment described in the specification or the drawings is exemplified as follows. This description is given in order to confirm that the embodiment supporting the present invention is described in the specification or the drawings. Therefore, even when there is an embodiment which is not described herein as an embodiment corresponding to the constituent requirements of the present invention although it is described in the specification or the drawings, this does not mean that the embodiment concerned does not correspond to the constituent requirements of the present invention. Conversely, even when an embodiment is described herein as one corresponding to the constituent requirements, this does not mean that the embodiment concerned does not correspond to any of the constituent requirements other than the constituent requirements concerned.

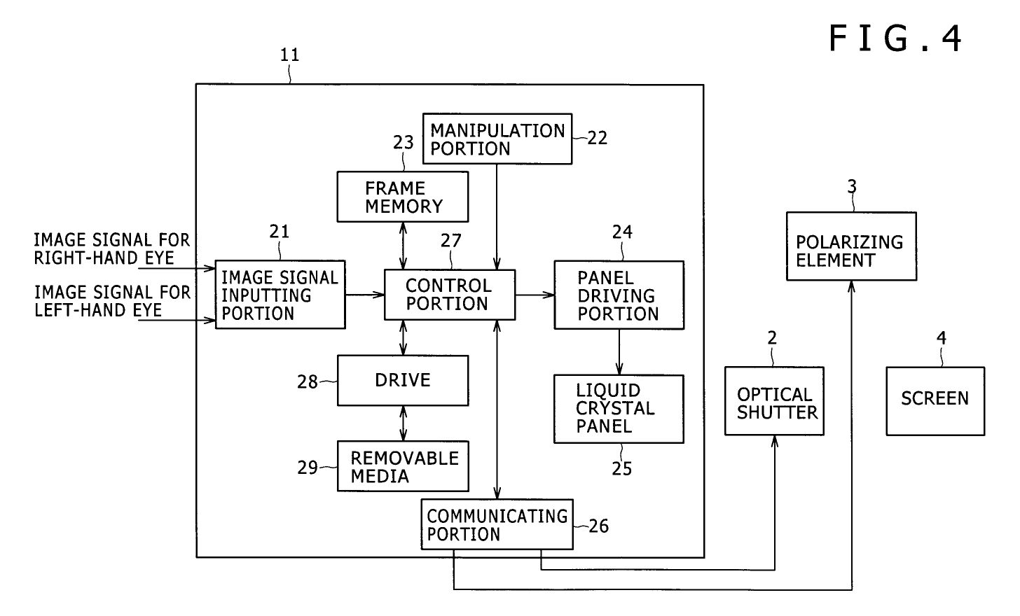

According to the correspondence relationship described above, a liquid crystal projector (for example, a liquid crystal projector 11 of FIG. 4) for projecting a three-dimensional image based on an image signal for a left-hand eye and an image signal for a right-hand eye includes: a liquid crystal panel (for example, a liquid crystal panel 25 of FIG. 4) to which a normal voltage and an inversion voltage are alternately applied; and a drive circuit (for example, a control portion 27 of FIG. 4) for driving the liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

The liquid crystal projector described above further includes: first and second memories (for example, banks 23A and 23B) for storing therein the first image signal and the second image signal); and a memory controlling circuit (for example, a panel driving portion 24 of FIG. 4) for controlling read-out and write of the first image signal and the second image signal from and to the first and second memories. In this case, while writing the first image signal and the second image signal to the first memory for a first time period, the memory controlling circuit described above reads out the first image signal and the second image signal stored in the second memory twice each for a previous time period of the first time period in order of the first image signal, the second image signal, the first image signal, and the second image signal.

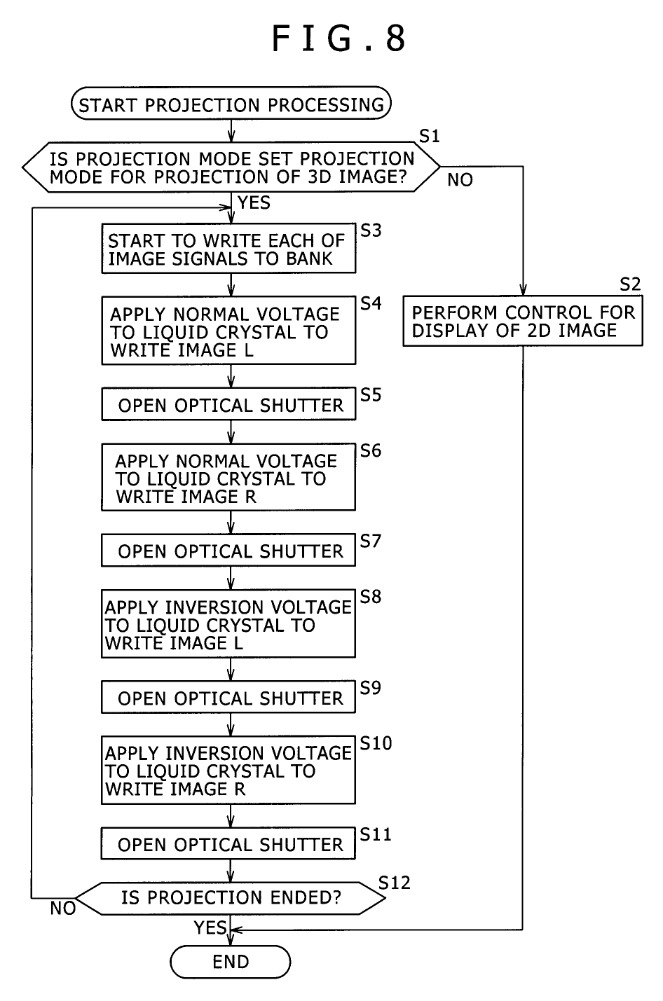

According to the another correspondence relationship described above, a method of controlling a liquid crystal projector (for example, the liquid crystal projector 11 of FIG. 4) including a liquid crystal panel to which a normal voltage and an inversion voltage are alternately applied, the liquid crystal projector serving to project a three-dimensional image based on an image signal for a left-hand eye and an image signal for a right-hand eye, the method of controlling a liquid crystal projector including the step (for example, steps S4, S6, S8 and S10 of FIG. 8) of: driving the liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

An embodiment of the present invention will be described in detail hereinafter with reference to the accompanying drawings.

FIG. 4 is a block diagram showing a configuration of a 3D image projecting system according to an embodiment of the present invention.

The 3D image projecting system shown in FIG. 4 is composed of the liquid crystal projector 11, the optical shutter 2, the polarizing element 3, and the screen 4. The liquid crystal projector 11 projects a 3D image on the screen 4.

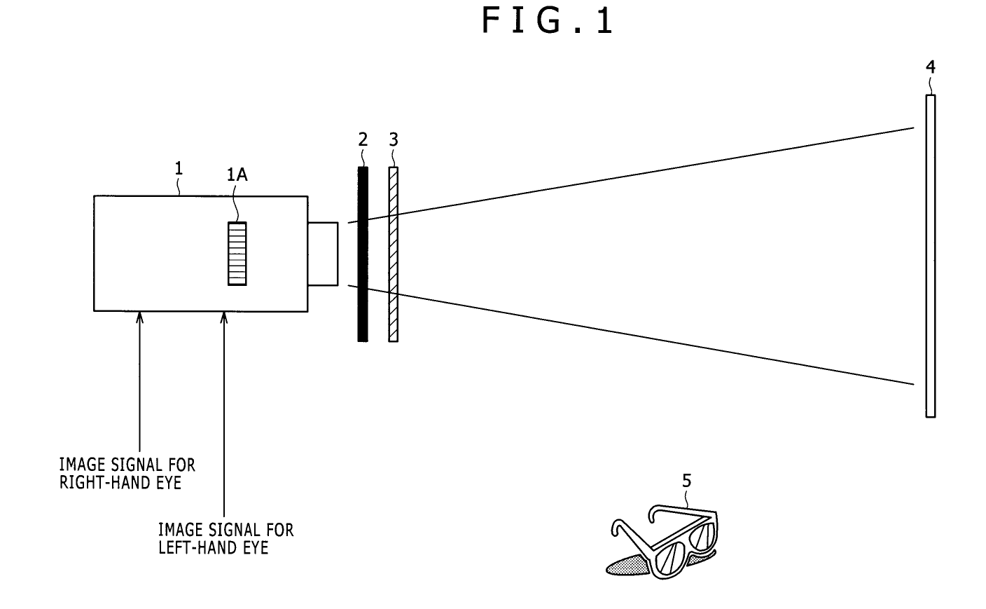

That is to say, with the 3D image projecting system shown in FIG. 4, similarly to the case of the 3D image projecting system in the related art shown in FIG. 1, an image light emitted from the liquid crystal projector 11 passes through the optical shutter 2 and is then polarized in a predetermined polarization direction by the polarizing element 3 to be projected on the screen 4. When the image light for a left-hand eye of a user is emitted from the liquid crystal projector 11, the polarizing element 3 polarizes the image light for the left-hand eye of the user in the polarization direction for the left-hand eye of the user. On the other hand, when the image light for a right-hand eye of the user is emitted from the liquid crystal projector 11, the polarizing element 3 polarizes the image light for the right-hand eye of the user in the polarization direction for the right-hand eye of the user. The polarization direction for the right-hand eye of the user, and the polarization direction for the left-hand eye of the user, for example, make a right angle with each other.

The user wears polarization glasses. Thus, the image light for the left-hand eye of the user, and the image light for the right-hand eye of the user are made incident to the left-hand eye and right-hand eye of the user, respectively. As a result, the user can see the image displayed on the screen as the 3D image.

It is noted that the liquid crystal projector 11, of course, can display the 2D image as well on the screen 4. However, a description will be mainly given hereinafter with respect to the case where the liquid crystal projector 11 displays a 3D image on the screen 4. Also, a supplementary description will be given hereafter with respect to the case where the liquid crystal projector 11 displays a 2D image on the screen 4 as may be necessary.

The liquid crystal projector 11 is composed of an image signal inputting portion 21, a manipulation portion 22, a frame memory 23, a panel driving portion 24, a liquid crystal panel 25, a communicating portion 26, a control portion 27, and a drive 28. In addition, the drive, for example, can be equipped with a removable media 29 as a package media constituted by a magnetic disk (including a flexible disc), an optical disk (such as a Compact Disc-Read Only Memory (CD-ROM) or a Digital Versatile Disc (DVD)), a magnet-optical disk, or a semiconductor memory as may be necessary.

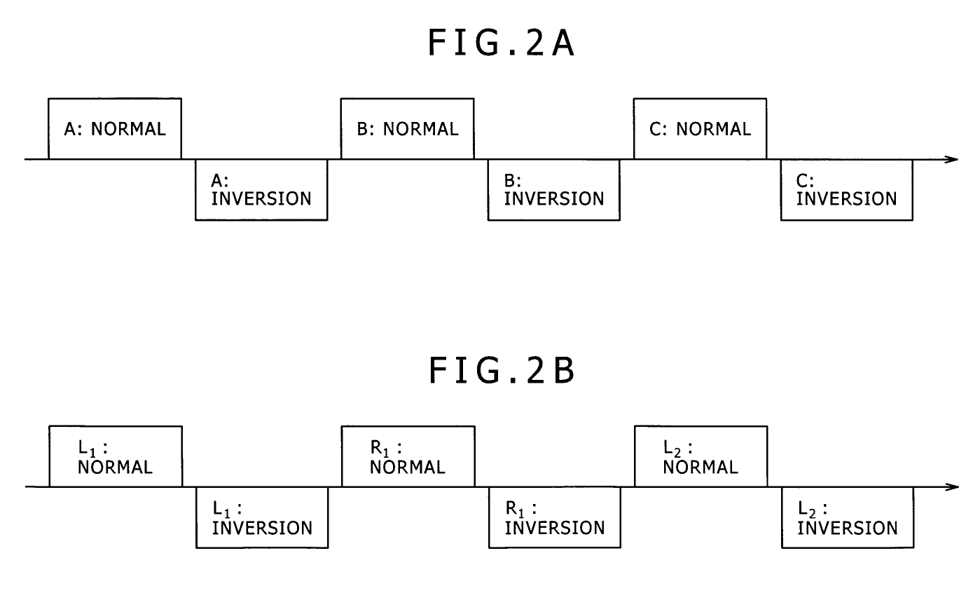

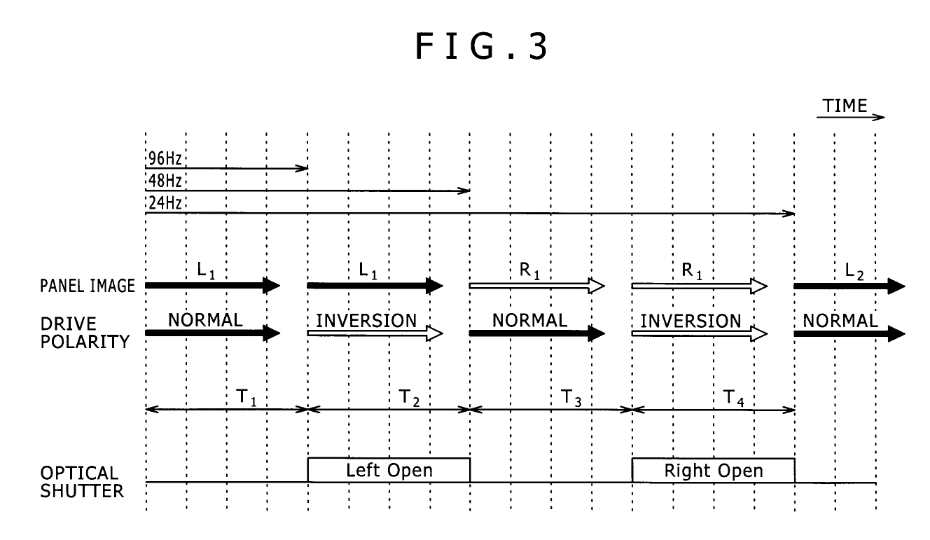

An image signal for the left-hand eye, and an image signal for the right-hand eye are simultaneously inputted to the image signal inputting portion 21 in a cycle of 24 Hz. The image signal inputting portion 21 supplies the image signal for the left-hand eye, and the image signal for the right-hand eye thus inputted thereto to the control portion 27. It is noted that when the image signal for the left-hand eye, and the image signal for the right-hand eye, or the image signal inputted in a time series manner are distinguished from one another hereafter, these images are expressed by the images L₁, L₂, L₃, . . . , and the image R₁, R₂, R₃, . . . , respectively, similarly to the case shown in FIGS. 2 and 3. In addition, the image signals numbers of suffixes of which correspond to the same image represent ones which are simultaneously inputted to the image signal inputting portion 21.

The manipulation portion 22 is composed of manipulation buttons, a display portion, etc. (not shown), and receives a predetermined manipulation made by an operator. A manipulation signal corresponding to the manipulation made by the operator is supplied from the manipulation portion 22 to the control portion 27. For example, the operator can set a projection mode representing whether the 2D image or the 3D image is projected on the screen 4 by manipulating the manipulation portion 22. Thus, a manipulation signal about the projection mode thus set is supplied from the manipulation portion 22 to the control portion 27.

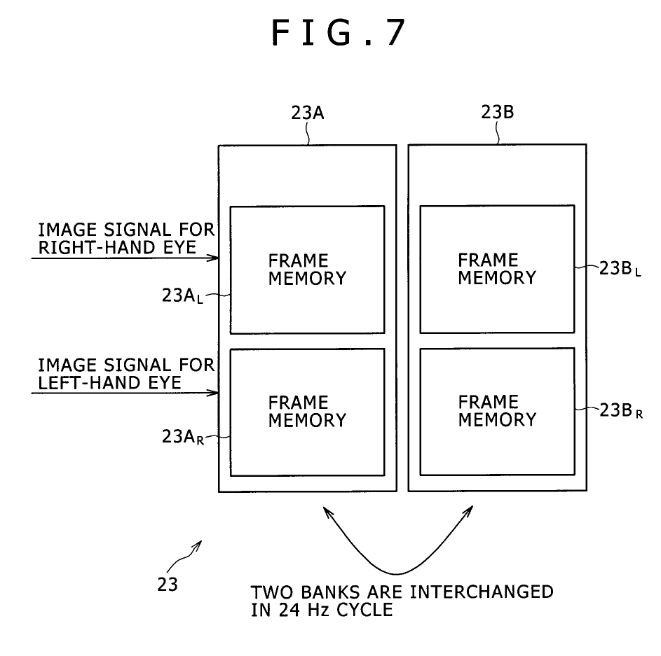

The frame memory 23 temporarily stores therein the image signal supplied from the image signal inputting portion 21, in other words, the image to be written to the liquid crystal of the liquid crystal panel 25. The frame memory 23 has a two-bank configuration as will be described later with reference to FIG. 7. Thus, the image signals are alternately written or read out to or from two banks 23A and 23B (refer to FIG. 7).

The panel driving portion 24, for example, is constituted by a drive circuit, and drives the liquid crystal panel 25 in accordance with a drive control signal supplied from the control portion 27. The panel driving portion 24 applies a normal voltage or an inversion voltage to the liquid crystal of the liquid crystal panel 25 to write a predetermined image corresponding to the image signal to the liquid crystal panel 25. However, as previously described above, for the purpose of preventing the deterioration or the like of the liquid crystal material, the panel driving portion 24 drives (A.C.-drives) the liquid crystal panel 25 so that an integration value of a D.C. component becomes zero. A light corresponding to the image written to the liquid crystal panel 25 is emitted from the liquid crystal projector 11 by using a light source (not shown) to be projected on the screen 4.

The communicating portion 26 supplies a control signal supplied thereto from the control portion 27 to the optical shutter 2 or the polarizing element 3. The control signal supplied to the optical shutter 2 is one in accordance with which opening and closing of the optical shutter 2 are controlled. On the other hand, the control signal supplied to the polarizing element 3 is one in accordance with which the polarization direction of the polarizing element 3 is controlled.

The control portion 27, for example, is constituted by a Central Processing Unit (CPU), a control circuit or the like, and controls the operations of the portions in the liquid crystal projector 11. For example, the control portion 27 writes the image signal supplied from the image signal inputting portion 21 to the frame memory 23, reads out the image signal from the frame memory 23, and supplies the drive control signal corresponding to the image signal thus read out to the panel driving portion 24. In addition, the control portion 27 supplies the control signal to the optical shutter 2 or the polarizing element 3 through the communicating portion 26 in correspondence to the image written to the liquid crystal panel 25, thereby controlling the opening and closing of the optical shutter 2, or the polarization direction of the polarizing element 3.

The drive 28 drives the removable media 29 to read out the image signal recorded in the removable media 29, and supplies the image signal thus read out to the control portion 27. Also, the drive 28 writes the image signal supplied thereto from the control portion 27 to the removable media 29.

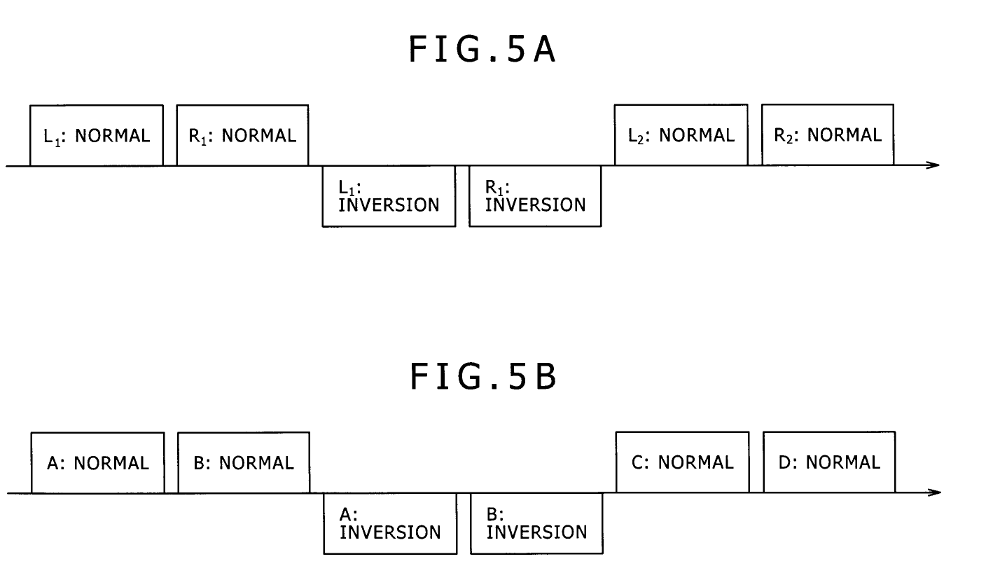

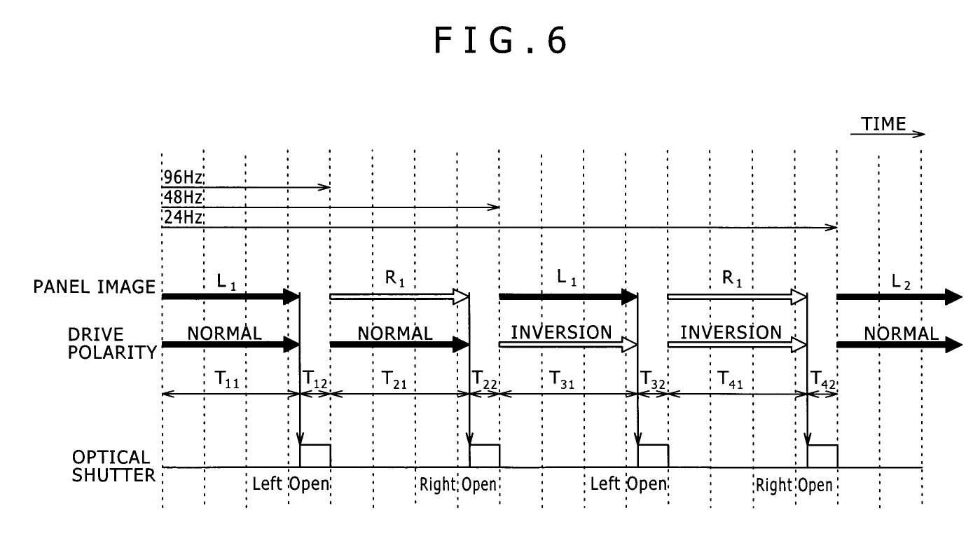

A description will now be given with respect to the drive control in the case where the 3D image is projected with the liquid crystal projector 11 configured as described above with reference to FIGS. 5 and 6.

The image signals are inputted in order of the image signals about images L₁ and R₁, the image signals about images L₂ and R₂, the image signals about images L₃ and R₃, . . . to the image signal inputting portion 21, and are successively stored in the frame memory 23 through the control portion 27. The control portion 27 reads out the image signal from the frame memory 23, and supplies the drive control signal corresponding to the image signal thus read out to the panel driving portion 24. The panel driving portion 24 drives the liquid crystal panel 25 in the manner as shown in FIG. 5A in accordance with the drive control signal supplied thereto from the control portion 27. That is to say, firstly, the panel driving portion 24 applies the normal voltage obtained by inverting the inversion voltage to the liquid crystal of the liquid crystal panel 25 to write the image L₁ to the liquid panel 25. Next, the panel driving portion 24 similarly applies the normal voltage to the liquid crystal of the liquid crystal panel 25 to write the image R₁ to the liquid panel 25. Subsequently, the panel driving portion 24 applies the inversion voltage obtained by inverting the normal voltage to the liquid crystal of the liquid crystal panel 25 to write the image L₁ to the liquid panel 25. Subsequently, the panel driving portion 24 similarly applies the inversion voltage to the liquid crystal of the liquid crystal panel 25 to write the image R₁ to the liquid panel 25.

After completion of the processing described above, the same processing as that described above is repeatedly executed. That is to say, the images L₂ and R₂ are written in order of the image L₂ (corresponding to the normal), the image R₂ (corresponding to the normal), the image L₂ (corresponding to the inversion), and the image R₂ (corresponding to the inversion) to the liquid crystal panel 25.

When the drive control shown in FIG. 5A is made to correspond to the case where 2D images A, B and C are successively displayed, as shown in FIG. 5B, the images are written in order of the image A (normal), the image B (normal), the image A (inversion), and the image B (inversion) to the liquid crystal panel 25. That is to say, the two normal voltages each being obtained by inverting the inversion voltage are applied to the liquid crystal of the liquid crystal panel 25 to write the images A and B in this order to the liquid crystal panel 25, respectively. After that, the two inversion voltages each being obtained by inverting the normal voltage are applied to the liquid crystal of the liquid crystal panel 25 to write the images A and B in this order to the liquid crystal panel 25, respectively. Subsequently, the two normal voltages each being obtained by inverting the inversion voltage are applied to the liquid crystal of the liquid crystal panel 25 to write the images C and D in this order to the liquid crystal panel 25, respectively. Thereafter, the two inversion voltages each being obtained by inverting the normal voltage are applied to the liquid crystal of the liquid crystal panel 25 to write the images C and D in this order to the liquid crystal panel 25, respectively.

In other words, comparing the system for projecting the 3D image by using the liquid crystal projector 11 with the system in the related art shown in FIG. 2A, it can be said that the liquid crystal projector 11 performs the drive control so as to interchange the image A (inversion) and the image B (normal) shown in FIG. 2A with each other in a time axis direction.

FIG. 6 is a diagram showing a timing between each of a panel image and a drive polarity in the liquid crystal projector 11, and the opening and closing of the optical shutter 2. In this case, the drive control shown in FIG. 6 corresponds to the drive control in the related art shown in FIG. 3.

The control portion 27 continues to open the optical shutter 25 for a time period T₁₂ until start of write of the image R₁ to the liquid crystal panel 25 after the normal voltage obtained by inverting the inversion voltage is applied to the liquid crystal of the liquid crystal panel 25 to write the image L₁ to the liquid crystal panel 25 for a time period T₁₁. The normal voltage is applied to the liquid crystal of the liquid crystal panel 25 to write the image R₁ to the liquid crystal panel 25 for a time period T₂₁ next to the time period T₁₂. Also, the control portion 27 continues to open the optical shutter 2 for a time period T₂₂ until start of write of the image L₁ to the liquid crystal panel 25.

Moreover, the control portion 27 continues to open the optical shutter 2 for a time period T32 until start of write of the image R₁ to the liquid crystal panel 25 after the inversion voltage obtained by inverting the normal voltage is applied to the liquid crystal of the liquid crystal panel 25 to write the image L₁ to the liquid crystal panel 25 for a time period T₃₁ next to the time period T₂₂. Also, the control portion 27 continues to open the optical shutter 2 for a time period T₄₂ until start of write of the image L₂ to the liquid crystal panel 25 after the inversion voltage is applied to the liquid crystal of the liquid crystal panel 25 to write the image R₁ to the liquid crystal panel 25 for a time period T₄₁ next to the time period T₃₂.

The image signal for the left-hand eye, and the image signal for the right-hand eye are inputted in the cycle of 24 Hz to the image signal inputting portion 21, and are then written to the frame memory 23 through the control portion 27. Thus, the processing for successively reading out the image signal about the image L₁ (normal), the image signal about the image R₁ (normal), the image signal about the image L₁ (inversion), and the image signal about the image R₁ (inversion), and successively writing the image signal about the image L₁ (normal), the image signal about the image R₁ (normal), the image signal about the image L₁ (inversion), and the image signal about the image R₁ (inversion) to the liquid crystal panel 25 is also executed in the cycle of 24 Hz accordingly. As a result, the image is displayed twice within the time period corresponding to one cycle of 24 Hz.

Therefore, the flicker can be greatly reduced because with the liquid crystal projector 11, the 3D image can be displayed in the cycle of 48 Hz which is double the cycle of 24 Hz.

Next, a description will now be further given with respect to the operation for reading out the image signal about the image L (normal), the image signal about the image R (normal), the image signal about the image L (inversion), and the image signal about the image R (inversion) from the frame memory 23 with reference to FIG. 7. FIG. 7 shows an example of a detailed configuration of the frame memory 23.

The frame memory 23 is composed of two banks 23A and 23B. Each of the two banks 23A and 23B has two frame memories for storing therein the image signal for the left-hand eye, and the image signal for the right-hand eye, respectively. That is to say, the bank 23A has frame memories 23A_{L} and 23A_{R}, and the bank 23B has frame memories 23B_{L} and 23B_{R}.

The operation for reading out the image signal, and the operation for writing the image signal are alternately performed in the cycle of 24 Hz in the banks 23A and 23B.

For example, for a time period corresponding to certain one cycle in the cycle of 24 Hz, the image signal about the image L₂ and the image signal about the image R₂ which are supplied from the control portion 27 are written to the frame memories 23A_{L} and 23A_{R} of the bank 23B, respectively. At the same time, the image signal about the image L₁ and the image signal about the image R₁ which are stored in the frame memories 23B_{L} and 23B_{R} of the bank 23B, respectively, are read out.

Here, in the phase of reading out the image signals from the bank 23B, the image signal about the image L₁ and the image signal about the image R₁ need to be read out twice each in order of the image signal about the image L₁, the image signal about the image R₁, the image signal about the image L₁, and the image signal about the image R₁ for a time period corresponding to one cycle. Therefore, a reading-out speed becomes four times as high as a writing speed.

For a next time period corresponding to one cycle, the image signal about the image L₃, and the image signal about the image R₃ which are supplied from the control portion 27 are written to the frame memories 23B_{L} and 23B_{R} of the bank 23B, respectively. Concurrently with this writing operation, the image signal about the image L₂, and the image signal about the image R₂ which are stored in the frame memories 23A_{L} and 23A_{R} of the bank 23A, respectively, are read out in order of the frame memories 23A_{L}, 23A_{R}, 23A_{L} and 23A_{R} at a reading-out speed which is four times as high as the writing speed.

Note that, when the liquid crystal projector 11 projects the 2D image on the screen 4, the operation for reading out the image signal, and the operation for writing the image signal are alternately performed by using one frame memories (for example, the frame memories 23A_{L} and 23B_{L}) of the banks 23A and 23B, thereby allowing the 2D image to be displayed on the screen 4.

Next, projection processing executed by the liquid crystal projector 11 will now be described in detail with reference to a flow chart of FIG. 8. This projection processing starts to be executed, for example, when a projection start button in the manipulation portion 22 is manipulated by the operator.

Firstly, in step S1, the control portion 27 determines whether or not the projection mode set is a projection mode for projection of the 3D image. When it is determined in step S1 that the projection mode set is not the projection mode for projection of the 3D image (No: in step S1), that is, when the projection mode set is a projection mode for projection of the 2D image, the processing proceeds to step S2. Then, and the control portion 27 performs the control so as to display the 2D image on the screen 4. In this case, the panel driving portion 24 performs the drive control so as to display the 2D image as previously described with reference to FIG. 2A. Also, the control portion 27 performs the control so as to open and close the optical shutter 2 as previously stated with reference to FIG. 3. This projection proceeding ends when the image signal about the image to be projected comes not to be inputted to the image signal inputting portion 21.

On the other hand, when it is determined in step S1 that the projection mode set is the projection mode for projection of the 3D image (Yes: in step S1), the processing proceeds to step S3. Then, the control portion 27 starts to write each of the image signal for the right-hand eye, and the image signal for the left-hand eye which are supplied from the image signal inputting portion 21 to the bank 23A of the frame memory 23. The processing, for writing each of the image signal for the right-hand eye, and the image signal for the left-hand eye to the bank 23A of the frame memory 23, which starts in step S3 is executed in parallel with the processing from step S4 to step S11 which will be described later until completion of the processing from step S4 to step S11.

In step S4, the control portion 27 reads out the image signal about the image L from the frame memory 23B_{L} of the bank 23B. Also, the control portion 27 supplies the drive control signal corresponding to the image signal about the image L thus read out to the panel driving portion 24. As a result, the panel driving portion 24 applies the normal voltage obtained by inverting the inversion voltage to the liquid crystal of the liquid crystal panel 25, thereby writing the image L to the liquid crystal panel 25.

After completion of the processing for writing each of the image signal for the right-hand eye, and the image signal for the left-hand eye to the bank 23A of the frame memory 23, in step S5, the control portion 27 supplies the control signal to the optical shutter 2 through the communicating portion 26 to open the optical shutter 2. Also, the control portion 27 supplies the control signal to the polarizing element 3 through the communicating portion 26 to control the polarizing element 3 so as to provide the polarization direction for the left-hand eye.

In step S6, the control portion 27 supplies the control signal to the optical shutter 2 through the communicating portion 26 to close the optical shutter 2. Also, the control portion 27 reads out the image signal about the image R from the frame memory 23B_{R} of the bank 23B, and supplies the drive control signal corresponding to the image signal about the image R thus read out to the panel driving portion 24. As a result, the panel driving portion 24 applies the normal voltage to the liquid crystal of the liquid crystal panel 25 to write the image R to the liquid crystal panel 25.

After completion of the processing for writing the image R to the liquid crystal panel 25, in step S7, the control portion 27 supplies the control signal to the optical shutter 2 through the communicating portion 26 to open the optical shutter 2. Also, the control portion 27 supplies the control signal to the polarizing element 3 through the communicating portion 26 to control the polarizing element 3 so as to provide the polarization direction for the right-hand eye.

In step S8, the control portion 27 supplies the control signal to the optical shutter 2 through the communicating portion 26 to close the optical shutter 2. Also, the control portion 27 reads out the image signal about the image L from the frame memory 23B_{L} of the bank 23B, and supplies the drive control signal corresponding to the image signal about the image L thus read out to the panel driving portion 24. As a result, the panel driving portion 24 applies the inversion voltage obtained by inverting the normal voltage to the liquid crystal of the liquid crystal panel 25 to write the image L to the liquid crystal panel 25.

After completion of the processing for writing the image L to the liquid crystal panel 25, in step S9, the control portion 27 supplies the control signal to the optical shutter 2 through the communicating portion 26 to open the optical shutter 2. Also, the control portion 27 supplies the control signal to the polarizing element 3 through the communicating portion 26 to control the polarizing element 3 so as to provide the polarization direction for the left-hand eye.

In step S10, the control portion 27 supplies the control signal to the optical shutter 2 through the communicating portion 26 to close the optical shutter 2. Also, the control portion 27 reads out the image signal about the image R from the frame memory 23B_{R} of the bank 23B, and supplies the drive control signal corresponding to the image signal about the image R thus read out to the panel driving portion 24. As a result, the panel driving portion 24 applies the inversion voltage to the liquid crystal of the liquid crystal panel 25 to write the image R to the liquid crystal panel 25.

After completion of the processing for writing the image R to the liquid crystal panel 25, in step S11, the control portion 27 supplies the control signal to the optical shutter 2 through the communicating portion 26 to open the optical shutter 2. Also, the control portion 27 supplies the control signal to the polarizing element 3 through the communicating portion 26 to control the polarizing element 3 so as to provide the polarization direction for the right-hand eye.

In step S12, the control portion 27 determines whether or not the projection is ended. In step S12, for example, when no new image signal is supplied from the image signal inputting portion 21 to the control portion 27, or when an end button with which the projection is ended is manipulated in the manipulation portion 22 by the operator, the control portion 27 determines that the projection is ended (Yes: in step S12). As a result, the processing is ended.

On the other hand, when it is determined in step S12 that the projection is not ended (No: in step S12), the processing returns back to step S3, and the processing from step S3 to step S12 is repeatedly executed. However, in the processing from step S3 to step S12 which is executed next time, in the frame memory 23, the bank from which the image signal is read out, and the bank to which the image signal is written is interchanged with each other. That is to say, in the processing from step S3 to step S12 which is executed next time, the image signal is written to the bank 23B, and the image signal is read out from the bank 23A. In the processing from step S3 to S12 which is subsequently executed, the image signal is written to the bank 23B, and the image signal is read out from the bank 23A. Hereafter, the processing is repeatedly executed in a similar way. When it is determined in step S12 that the projection is ended (Yes: in step S12), the processing is ended.

As described above, according to the liquid crystal projector 11 shown in FIG. 4, the liquid crystal panel 25 is driven in order of the image L (normal), the image R (normal), the image L (inversion), and the image R (inversion). As a result, the 3D image for which the flicker is largely reduced can be displayed while the condition necessary for the liquid crystal device is fulfilled in which the integration value of the D.C. component becomes zero.

It is noted that although there is shown the example in which the liquid crystal panel 25 is repeatedly driven in order of the image L (normal), the image R (normal), the image L (inversion), and the image R (inversion), the normal and the inversion may be reversed. That is to say, the liquid crystal panel 25 may be repeatedly driven in order of the image L (inversion), the image R (inversion), the image L (normal), and the image R (normal).

In addition, the order of the image L and the image R may be reversed. That is to say, the liquid crystal panel 25 may be repeatedly driven in order of the image R (normal), the image L (normal), the image R (inversion), and the image L (inversion). Moreover, the liquid crystal panel 25 may also be repeatedly driven in order of the image R (inversion), the image L (inversion), the image R (normal), and the image L (normal).

That is to say, one of the image signal for the left-hand eye, and the image signal for the right-hand eye may be set as a first image signal, and the other thereof may be set as a second image signal. One of the normal state of the voltage applied to the liquid crystal panel 25, and an inversion state of the voltage applied to the liquid crystal panel 25 may be set as a first state, and the other thereof may be set as a second state. Also, the liquid crystal panel 25 may be driven in order of the first state corresponding to the first image signal, the first state corresponding to the second image signal, the second state corresponding to the first image signal, and the second state corresponding to the second image signal.

In the example described above, the display (projection) of the 3D image, and the display (projection) of the 2D image are changed over to each other in accordance with the manipulation signal supplied from the manipulation portion 22. However, for example, when information representing whether the image concerned is the 2D image or the 3D image is contained in the image signal, the control may be changed over to another one in accordance with the information.

In addition, although the example has been described in which the 3D image is projected based on the image signal inputted to the image signal inputting portion 21, the liquid crystal projector 11, of course, can project the 3D image, on the screen 4, the image signal about which is read out from the removable media 29 or the like. Moreover, either the optical shutter 2 or the polarizing element 3 may be built in the liquid crystal projector 11.

In this specification, steps stated in the flow chart of FIG. 8 include the processing which is executed in parallel or individually although not being necessarily processed in a time series manner as well as the processing which is executed in a time series manner in the order described.

It is noted that in this specification, the system means the entire system composed of a plurality of apparatuses (devices).

It should be noted that the embodiment of the present invention is by no means limited to one described above, and thus various changes can be made without departing from the gist of the present invention.

What is claimed is:

1. A liquid crystal projector for projecting a three-dimensional image based on an image signal for a left-hand eye and an image signal for a right-hand eye, said liquid crystal projector comprising:
a liquid crystal panel to which a normal voltage and an inversion voltage are alternately applied; and
a drive circuit for driving said liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to the liquid crystal panel, and an inversion state of the voltage applied to the liquid crystal panel being set as the first state, the other thereof being set as the second state.

2. The liquid crystal projector according to claim 1, wherein
said liquid crystal projector is adapted to project a two-dimensional image as well, and
said drive circuit changes a driving system for said liquid crystal panel between a case where the two-dimensional image is projected and a case where the three-dimensional image is projected.

3. The liquid crystal projector according to claim 1, further comprising:
first and second memories for storing therein the first image signal and the second image signal; and
a memory controlling circuit for controlling read-out and write of the first image signal and the second image signal from and to said first and second memories; wherein
while writing the first image signal and the second image signal to said first memory for a first time period, said memory controlling circuit reads out the first image signal and the second image signal stored in said second memory twice each for a previous time period of the first time period in order of the first image signal, the second image signal, the first image signal, and the second image signal.

4. A method of controlling a liquid crystal projector including a liquid crystal panel to which a normal voltage and an inversion voltage are alternately applied, said liquid crystal projector serving to project a three-dimensional image based on an image signal for a left-hand eye and an image signal for a right-hand eye, said method of controlling a liquid crystal projector comprising the step of
driving said liquid crystal panel in order of a first state corresponding to a first image signal, the first state corresponding to a second image signal, a second state corresponding to the first image signal, and the second state corresponding to the second image signal, one of the image signal for the left-hand eye and the image signal for the right-hand eye being set as the first image signal, the other thereof being set as the second image signal, one of a normal state of the voltage applied to said liquid crystal panel, and an inversion state of the voltage applied to said liquid crystal panel being set as the first state, the other thereof being set as the second state.
